(19) United States
(12) Patent Application Publication
(10) Pub. No.: US 2012/0065994 A1
(43) Pub. Date: Mar. 15, 2012

(54) Methods and systems for utilizing electronic medical records to track and manage radiation doses

(76) Inventors: Jeffrey D. Carter, Spotsylvania, VA (US); Andrew J. Hall, Wilmington, NC (US)

(21) Appl. No.: 12/807,743

(22) Filed: Sep. 13, 2010

(51) Int. Cl. G06Q 50/00; G06Q 10/00

(52) U.S. Cl. 705/3

(57) ABSTRACT

Methods and systems for utilizing electronic medical records are operative to track and manage radiation doses provided to patients through various different types of radiation-emitting medical procedures. According to an exemplary embodiment, one such method includes receiving an electronic medical record for a patient, the electronic medical record comprising data indicating a cumulative past amount of radiation exposure for the patient; detecting if the cumulative past amount of radiation exposure for the patient is above a threshold before performing a radiation-emitting medical procedure on the patient; and providing a pre-defined output message in response to detecting that the cumulative past amount of radiation exposure for the patient is above the threshold.

### BACKGROUND OF THE INVENTION

1. Field of the Invention

The present invention generally relates to health care management, and more particularly, to methods and systems capable of utilizing electronic medical records to, among other things, track and manage radiation doses provided to patients through various different types of radiation-emitting medical procedures.

2. Background Information

Medical patients are exposed to radiation through various different is types of radiation-emitting medical procedures. For example, patients may currently be exposed to radiation through medical procedures, such as X-rays, CAT scans, PET scans, CAT/PET scans, fluoroscopy procedures, nuclear medicine scans, mammography procedures, and oncology-related radiation therapy procedures. The amount of radiation delivered to (and absorbed by) a patient during a given one of these different medical procedures varies based on a plurality of different factors unique to the specific circumstances of the particular procedure in question.

At present, efforts are being made to reduce the amount of radiation delivered to patients during certain radiation-emitting medical procedures. Notwithstanding these efforts, there is still a great need in the art for systems and methods that enable health care providers to track and manage radiation doses provided to patients.

Accordingly, there is a need in the art to address the foregoing issues and thereby provide improved methods and systems for, among other things, utilizing electronic medical records to track and manage radiation doses provided to patients. The present invention described herein addresses these and/or other issues.

### SUMMARY OF THE INVENTION

In accordance with an aspect of the present invention, a method is disclosed. According to an exemplary embodiment, the method comprises: receiving, via a system, an electronic medical record for a patient, the electronic medical record comprising data indicating a cumulative past amount of radiation exposure for the patient, and wherein for at least one past medical procedure performed on the patient that exposed the patient to radiation, the electronic medical record further comprises data indicating at least one of an amount of radiation exposure to the patient from the past medical procedure, a date the past medical procedure was performed, a type of the past medical procedure, and a name of a facility associated with the past medical procedure; performing, via the system, a medical procedure on the patient and thereby exposing the patient to an additional amount of radiation; and updating, via the system, the electronic medical record after performing the medical procedure to thereby generate an updated electronic medical record for the patient that reflects the additional amount of radiation.

In accordance with another aspect of the present invention, another method is disclosed. According to an exemplary embodiment, the method comprises: storing, in a memory of a system, an electronic medical record for a patient, the stored electronic medical record comprising data indicating a cumulative past amount of radiation exposure for the patient; and wherein for at least one past medical procedure performed on the patient that exposed the patient to radiation, the electronic medical record for the patient further comprises data indicating at least one of: an amount of radiation exposure to the patient from the past medical procedure; a date the past medical procedure was performed; a type of the past medical procedure; and a name of a facility associated with the past medical procedure.

In accordance with yet another aspect of the present invention, a system is disclosed. According to an exemplary embodiment, the system comprises means for receiving an electronic medical record for a patient, the electronic medical record comprising data indicating a cumulative past amount of radiation exposure for the patient; and means for detecting if the cumulative past amount of radiation exposure for the patient is above a threshold and providing a pre-defined output message to an operator of the system in response to detecting that the cumulative past amount of radiation exposure for the patient is above the threshold.

The aforementioned summary of preferred and exemplary embodiments of the present invention is merely illustrative of the inventive concepts presented herein, and is not intended to limit the scope of the present invention in any manner.

### BRIEF DESCRIPTION OF THE DRAWINGS

The above-mentioned and other features and advantages of this invention, and the manner of attaining them, will become more apparent and is the invention will be better understood by reference to the following description of embodiments of the invention taken in conjunction with the accompanying drawings, wherein:

FIG. 1 shows a block diagram of a health care management system according to an exemplary embodiment of the present invention;

FIG. 2 shows a block diagram of a radiation-emitting system according to an exemplary embodiment of the present invention;

FIG. 3 shows an electronic medical record presented on a display device according to an exemplary embodiment of the present invention; and

FIG. 4 shows a flowchart including steps according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

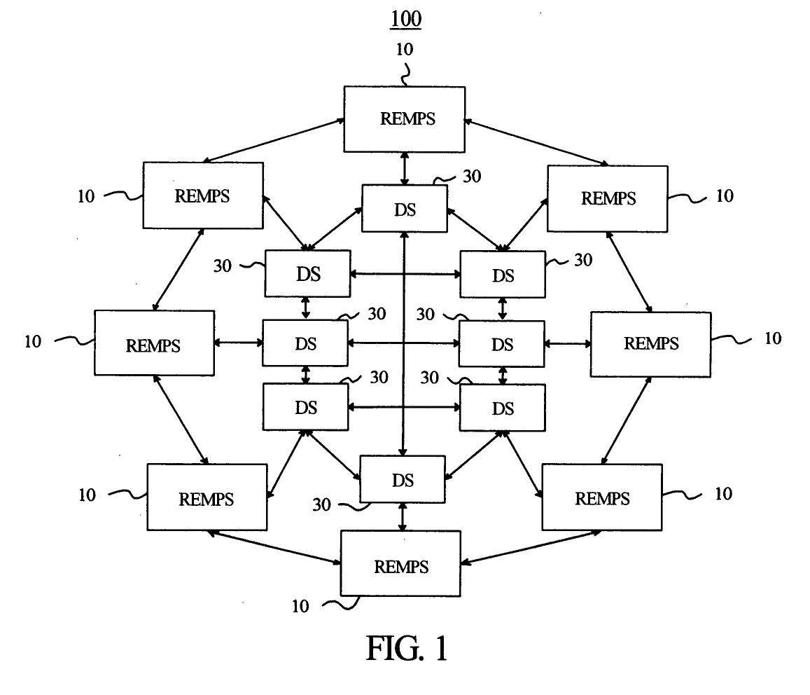

Referring now to the drawings, and more particularly to FIG. 1, a block diagram of a health care management system 100 according to an exemplary embodiment of the present invention is shown. As shown in FIG. 1, health care management system 100 comprises a plurality of radiation-emitting medical procedure systems (REMPS) 10 and a plurality of data storage systems (DS) 30. According to an exemplary embodiment, health care management system 100 of FIG. 1 exists within the facilities of one or more health care providers (HCPs), such as one or more hospitals, medical centers, physicians' (including dentists) offices, and/or the like.

According to principles of the present invention, each radiation-emitting medical procedure system (REMPS) 10 is operatively coupled to at least one other radiation-emitting medical procedure system (REMPS) 10 and/or data storage system (DS) 30 for purposes of communicating data comprising electronic medical records (EMRs) for patients. The specific configuration of health care management system 100 shown in FIG. 1 is exemplary only, and is not intended to limit the applicability of the present invention in any manner.

According to an exemplary embodiment, each of the radiation-emitting medical procedure systems (REMPS) 10 of FIG. 1 is operative to perform one or more medical procedures on patients that expose such patients to radiation during the performance of such medical procedures. According to an exemplary embodiment, each radiation-emitting medical procedure system (REMPS) 10 of FIG. 1 is operative to perform at least one of an X-ray, a CAT scan, a PET scan, a CAT/PET scan, a fluoroscopy procedure, a nuclear medicine scan, a mammography procedure, and an oncology-related radiation therapy procedure.

Other types of radiation-emitting medical procedures may be introduced in the future. Those skilled in the art will readily recognize that the aforementioned types of radiation-emitting medical procedures may be performed via different types of specific equipment and systems. The principles of the present invention described herein apply to all such equipment and systems.

Data storage systems (DS) 30 of FIG. 1 are each operative to store data including access-limited, confidential data, such as electronic medical records (EMRs) for patients. Each data storage system (DS) 30 of FIG. 1 may store, for example, electronic medical records (EMRs) for one or more specific health insurance companies and/or one or more specific health care providers (HCPs). The transfer of electronic medical records (EMRs) in FIG. 1 between and among the respective radiation-emitting medical procedure systems (REMPS) 10 and/or data storage systems (DS) 30 may be protected, for example, using passwords and/or encryption.

Also according to an exemplary embodiment, there may be a fee charged by an entity associated with a given radiation-emitting medical procedure system (REMPS) 10 and/or data storage system (DS) 30 storing a given electronic medical record (EMR). Separately, there may also be a fee charged by an entity associated with a given radiation-emitting medical procedure system (REMPS) 10 and/or data storage system (DS) 30 transferring a given electronic medical record (EMR) to another radiation-emitting medical procedure system (REMPS) 10 and/or data storage system (DS) 30.

According to the exemplary embodiments described herein, health management system 100 provides multiple benefits and advantages over conventional systems by providing at least the following features: (i) an improved electronic medical record (EMR) which comprises, for each patient, a plurality of updateable data fields which indicate, among other things, a cumulative past radiation dose for a given patient and other valuable information related to the patient's radiation exposure from past medical procedures; (ii) the ability of an operator of a radiation-emitting medical procedure system (REMPS) 10 to set radiation thresholds on a patient-by-patient basis; (iii) the ability for an operator of a radiation-emitting medical procedure system (REMPS) 10 to be alerted if the cumulative past radiation dose for a given patient is above the threshold—this is typically performed in response to an operator request to initiate performance of a medical procedure on the patient that will expose the patient to an additional amount of radiation; (iv) the ability of a radiation-emitting medical procedure system (REMPS) 10 to automatically disable, and thereby prevent, performance of a radiation-emitting medical procedure in response to detecting that a cumulative past radiation dose for a given patient is above the threshold; and (v) the ability of the operator to override the radiation-emitting medical procedure system (REMPS) 10 when the performance of a radiation-emitting medical procedure is disabled, and thereby causing the requested radiation-emitting medical procedure to be performed on the patient even if the cumulative past radiation dose for a patient is above the threshold.

The aforementioned list of features of the present invention is not intended to be exhaustive. Moreover, any of the aforementioned features of the present invention may be utilized in combination in any suitable manner in accordance with the principles of the present invention.

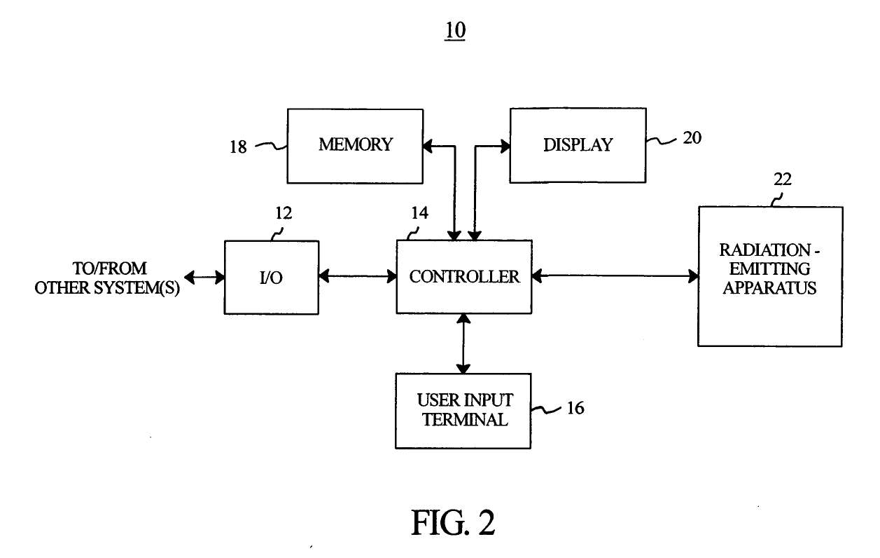

Referring to FIG. 2, a block diagram of a radiation-emitting medical procedure system (REMPS) 10, such as from FIG. 1, according to an exemplary embodiment of the present invention is shown. As shown in FIG. 2, radiation-emitting medical procedure system (REMPS) 10 comprises input/output (I/O) means such as I/O block 12, control means such as controller 14, user input means such as user input terminal 16, data storage means such as memory 18, display means such as display 20, and radiation-emitting means such as radiation-emitting apparatus 22.

The foregoing elements of FIG. 2 may be implemented using one or more stand-alone devices. The functionality of radiation-emitting medical procedure system (REMPS) 10 may, for example, be enabled through one or more computing systems, such as one or more personal computers (PCs). For clarity of description, certain conventional elements associated with radiation-emitting medical procedure system (REMPS) 10, such as certain control signals, power signals and/or other elements may not be expressly shown in FIG. 2.

According to an exemplary embodiment, radiation-emitting medical procedure system (REMPS) 10 of FIG. 2 represents a generic system for providing one or more medical procedures on patients that expose such patients to radiation during the performance of such medical procedures. According to an exemplary embodiment, the radiation-emitting medical procedure(s) performed and/or enabled by radiation-emitting medical procedure system (REMPS) 10 of FIG. 2 includes at least one of an X-ray, a CAT scan, a PET scan, a CAT/PET scan, a fluoroscopy procedure, a nuclear medicine scan, a mammography procedure, an oncology-related radiation therapy procedure, or other procedure/scan.

Other types of radiation-emitting medical procedures/scans may be introduced in the future, and the principles of the present invention disclosed herein apply to all such procedures/scans. Those skilled in the art will readily recognize that the aforementioned types of radiation-emitting medical procedures may be performed via different types of specific equipment and systems. The principles of the present invention described herein apply to all such equipment and systems.

I/O block 12 is operative to perform various I/O functions of radiation-emitting medical procedure system (REMPS) 10. According to an exemplary embodiment, I/O block 12 is operative to receive signals representing, for example, electronic medical records for patients that have had and/or may be scheduled to have radiation-exposing medical procedures performed thereon via radiation-emitting medical procedure system (REMPS) 10.

Controller 14 is operative to perform and/or enable various control, signal processing and/or memory functions of radiation-emitting medical procedure system (REMPS) 10. According to an exemplary embodiment, controller 14 is operative to execute software code that facilitates and enables performance of the various embodiments of the present invention described herein. Controller 14 is also operative to perform and/or enable other functions of radiation-emitting medical procedure system (REMPS) 10 including, but not limited to, processing user inputs made via user input terminal 16 or display 18, providing control signals to and receiving signals from radiation-emitting apparatus 22, enabling on-screen displays via display 18, reading and writing data from and to memory 18, and/or other operations as described herein.

User input terminal 16 is operative to receive user inputs from an operator of radiation-emitting medical procedure system (REMPS) 10. According to an exemplary embodiment, user input terminal includes one or more keys and/or other input elements (e.g., mouse, joystick, etc.). Inputs provided via user input terminal 16 are provided to controller 14 which processes such inputs.

Memory 18 is operatively coupled to controller 14 and performs data storage functions of radiation-emitting medical procedure system (REMPS) 10. According to an exemplary embodiment, memory 18 stores data including, but not limited to, electronic medical records (EMR) for one or more patients, software code, on-screen display (e.g., menu(s), etc.) data, operator selection/setup data, and/or other data.

Display 20 is operative to provide visual displays to an operator of radiation-emitting medical procedure system (REMPS) 10. According to an exemplary embodiment, display 20 may be embodied as any type of suitable display device, such as a light emitting diode (LED) display, liquid crystal display (LCD), cathode ray tube (CRT) display, plasma display, digital light processing (DLP) display or other type of display device. Display 20 may also have touch-screen capabilities and thereby enable an operator to provide inputs to controller 14.

Radiation-emitting apparatus 22 is operative to enable and/or perform medical procedures on patients that expose such patients to a dosage of radiation. According to an exemplary embodiment, radiation-emitting apparatus 22 may also be operative to measure and/or estimate radiation doses provided to patients during such medical procedures, and provide the results of such measurements and/or estimations to controller 14. Such medical procedures may be employed for various purposes, such as, for example, acquiring a medical image associated with a patient and/or providing radiation therapy to a patient. According to an exemplary embodiment, radiation-emitting apparatus 22 represents apparatus, device(s) and/or system(s) operative to provide one or more medical procedures on patients that expose such patients to radiation during the performance of such medical procedures.

According to an exemplary embodiment, the radiation-emitting medical procedure(s) performed and/or enabled by radiation-emitting apparatus 22 of FIG. 2 includes at least one of an X-ray, a CAT scan, a PET scan, a fluoroscopy procedure, a nuclear medicine scan, a mammography procedure, and an oncology-related radiation therapy procedure. Those skilled in the art will readily recognize that the aforementioned types of radiation-emitting medical procedures may be performed via different types of specific equipment and systems. The principles of the present invention described herein are intended to apply to all such equipment and systems.

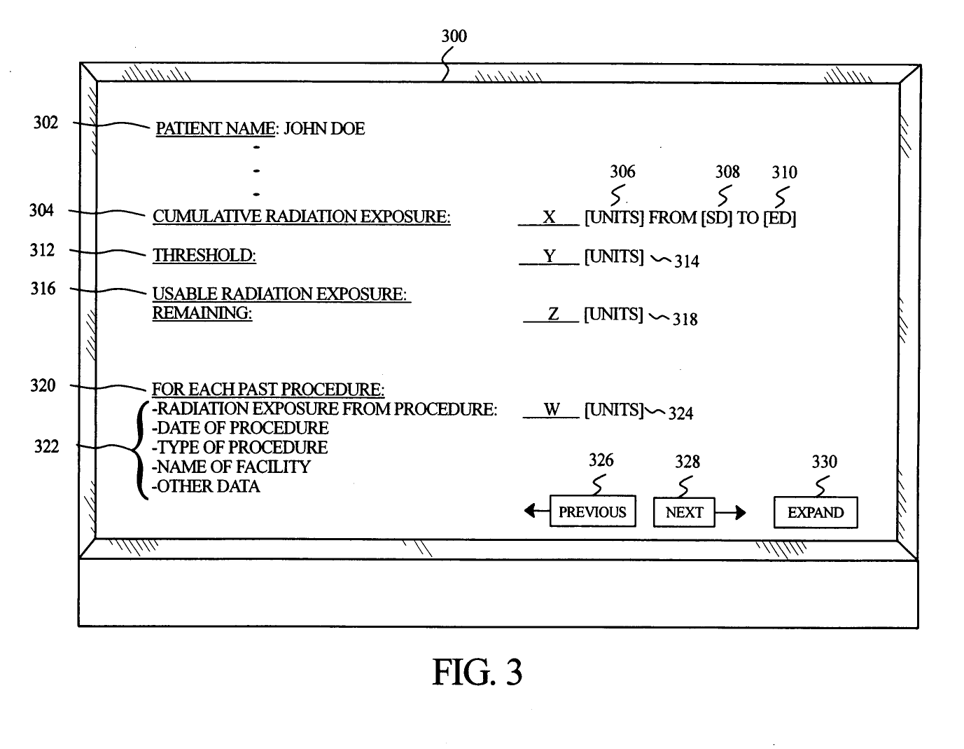

Referring to FIG. 3, an electronic medical record 300 according to an exemplary embodiment of the present invention presented on a display device, such as display device 20 of FIG. 2, is shown. According to the exemplary embodiment of FIG. 3, electronic medical record 300 corresponds to an individual patient (e.g. John Doe) and comprises a plurality of different data fields, including various data fields related to the patient's radiation exposure in past medical procedures. Certain basic data fields of electronic medical record 300, such as those related to the patient's date of birth, address, etc. are not shown in FIG. 3 for clarity of description.

As shown in FIG. 3, electronic medical record (EMR) 300 comprises one or more data fields 302 indicating a patient's name, and one or more data fields 304 indicating the patient's cumulative past amount of radiation exposure. According to an exemplary embodiment, the patient's cumulative past amount of radiation exposure is represented by “X” units 306 from a starting date (SD) 308 to an ending date (ED) 310. Units 306 may, for example, be expressed in rems, grey or rads, and the units 306 shown may be specified by an operator (e.g., via a drop down menu, etc.) to thereby enable the operator to view the patient's cumulative past amount of radiation exposure in different units, as specified by the operator. That is, the operator may choose to view the patient's cumulative past amount of radiation exposure in units of, for example, rems, grey or rads. The conversion between such units is performed by controller 14 of radiation-emitting medical procedure system (REMPS) 10. Starting date (SD) 308 and ending date (ED) 310 may also be adjusted by the operator (e.g., via a drop down menu, etc.) to thereby enable the operator to view the patient's cumulative past amount of radiation exposure for different time periods specified by the operator.

Electronic medical record (EMR) 300 further comprises one or more data fields 312 indicating a threshold amount of radiation exposure for the patient represented by “Y” units 314. According to an exemplary embodiment, the operator may establish and/or adjust the threshold amount of radiation exposure for the patient (e.g., via a drop down menu, etc.), and the units 314 of the threshold may be represented in, for example, rems, grey or rads. Electronic medical record (EMR) 300 further comprises one or more data fields 316 indicating a useable amount of radiation exposure remaining for the patient, which is represented by “Z” units 318, where “Z” is equal to “Y” minus “X”.

According to an exemplary embodiment, units 306, 314 and 318 are each shown and represented in the same units and an adjustment to any one of the units 306, 314 or 318 automatically causes the remaining ones to change accordingly. For example, if the operator adjusts units 306 to view the patient's cumulative past amount of radiation exposure 304 in rems, both units 314 for threshold 312 and units 318 for useable amount of radiation exposure remaining 316 are also automatically adjusted in real-time to be shown in rems. Adjustment between the other units (e.g., grey, rads, etc.) is performed in a similar manner. The conversion between such units is performed by controller 14 of radiation-emitting medical procedure system (REMPS) 10.

Electronic medical record (EMR) 300 further comprises one or more data fields 320 including information 322 from past radiation-emitting medical procedures for the patient. According to an exemplary embodiment, for each past radiation-emitting medical procedure recorded for the patient in electronic medical record (EMR) 300, information 322 indicates at least one of: an amount of radiation exposure to the patient from the past radiation-emitting medical procedure, a date the past radiation-emitting medical procedure was performed, a type of past radiation-emitting medical procedure, and a name of a facility (e.g., hospital, medical center, physicians' office, etc.) associated with the past radiation-emitting medical procedure. Other data may also be included. Although not expressly shown in FIG. 3, each past radiation-emitting medical procedure recorded for the patient in electronic medical record (EMR) 300 may have a separate numerical designation (e.g., 1, 2, 3, 4, 5 . . . ).

As indicated in FIG. 3, the amount of radiation exposure to the patient from a given past radiation-emitting medical procedure is represented by “W” units 324. Like units 306, 314 and 318 of FIG. 3, units 324 may also be represented, for example, in rems, grey or rads, as specified by an operator (e.g., via a drop down menu, etc.). According to an exemplary embodiment, units 324 are shown and represented in the same units as units 306, 314, 318 and 324 described above, and an adjustment to any one of the units 306, 314, 318 or 324 automatically causes the remaining ones to change accordingly. For example, if the operator adjusts units 324 to view the patient's radiation exposure from past radiation-emitting medical procedure in rads, units 306, 314 and 318 are also automatically adjusted in real-time to be shown in rads. The conversion between such units is performed by controller 14 of radiation-emitting medical procedure system (REMPS) 10. Although units of rems, grey and rads are expressly recited herein, other units indicative of radiation exposure may also be used according to principles of the present invention.

Electronic medical record (EMR) 300 further comprises a previous icon 326, a next icon 328 and an expand icon 330. According to an exemplary embodiment, previous icon 326 may be selected (e.g., via mouse, etc.) by the operator to view information 322 from a previous radiation-emitting medical procedure recorded in electronic medical record 300. Similarly, next icon 328 may be selected by the operator to view information 322 for a next radiation-emitting medical procedure recorded in electronic medical record (EMR) 300. In this manner, the operator may sequentially toggle among, and view important information relating to, various past radiation-emitting medical procedures for the patient recorded in electronic medical record (EMR) 300, while simultaneously viewing data fields 304, 312 and 316 for the patient.

Expand icon 330 is an optional feature which, when selected, allows the operator to view information 322 for a plurality of different past radiation-emitting medical procedures at the same time. For example, selection of expand icon 330 may cause one or more new screens (not shown in FIGS.) to to be displayed which each lists multiple sets of information 322 in an expanded view, such as in rows and columns or any other suitable manner.

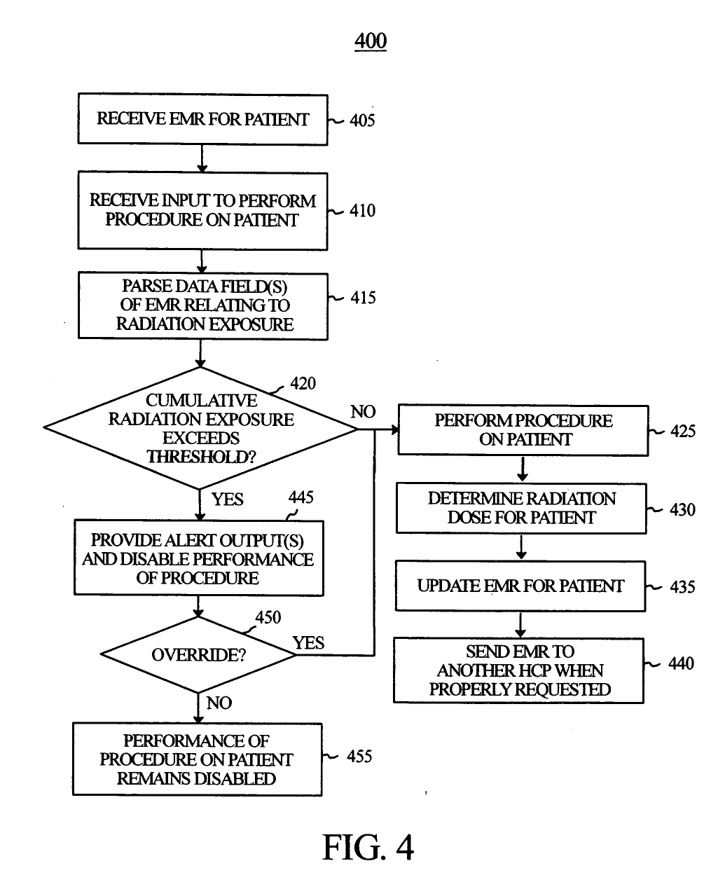

Referring to FIG. 4, a flowchart 400 including steps according to an exemplary embodiment of the present invention is shown. For purposes of example and explanation only, the steps of FIG. 4 may be described with specific reference to the exemplary embodiments of the present invention of FIGS. 1-3 previously described herein. Accordingly, the steps of FIG. 4 are exemplary only, and are not intended to limit the applicability of the present invention in any manner.

At step 405, an electronic medical record (EMR) 300 for a patient is received. According to an exemplary embodiment, a radiation-emitting medical procedure system (REMPS) 10 (see FIG. 1) receives the electronic medical record (EMR) 300 for the patient from an external source and/or facility (e.g., another radiation-emitting medical procedure system (REMPS) 10, a data storage system (DS) 30, etc.) via I/O block 12 and stores the electronic medical record (EMR) 300 in memory 18 under the control of controller 14.

At step 410, an input initiating performance of a radiation-emitting medical procedure on the patient is received by radiation-emitting medical procedure system (REMPS) 10. According to an exemplary embodiment, an operator (e.g., technician, physician, nurse, etc.) of radiation-emitting medical procedure system (REMPS) 10 provides the input at step 410 via user input terminal 16 to request initiation of the performance of a radiation-emitting medical procedure on the patient. Also according to an exemplary embodiment, the radiation-emitting medical procedure requested at step 410 is one of the following: an X-ray, a CAT scan, a PET scan, a fluoroscopy procedure, a nuclear medicine scan, a mammography procedure, and an oncology-related radiation therapy procedure.

According to an exemplary embodiment, steps 405 and 410 of FIG. 4 may be re-ordered such that the step of receiving the electronic medical record (EMR) 300 for the patient (i.e., step 405) may be performed in response to the input initiating performance of the radiation-emitting medical procedure (i.e., step 410). In this manner, steps 405 and 410 may be reversed, and radiation-emitting medical procedure system (REMPS) 10 may retrieve the electronic medical record (EMR) 300 for the patient from another is facility (e.g., another radiation-emitting medical procedure system (REMPS) 10 or a data storage system (DS) 30 of FIG. 1) in real-time and store the electronic medical record (EMR) 300 in memory 18 responsive to the input initiating performance of the radiation-emitting medical procedure on the patient in question under the control of controller 14.

At step 415, one or more data fields of the electronic medical record (EMR) 300 relating to past radiation exposure for the patient in question are parsed. According to an exemplary embodiment, controller 14 of the applicable radiation-emitting medical procedure system (REMPS) 10 retrieves electronic medical record (EMR) 300 for the patient in question from memory 18 in response to the operator input of step 410, and parses at least the data field(s) of the electronic medical record (EMR) 300 related to the patient's cumulative past radiation exposure (see element 304 of FIG. 3) at step 415.

At step 420, a determination is made as to whether the cumulative past radiation exposure for the patient in question exceeds a threshold. According to a variation of step 420, a determination is made as to whether the cumulative past radiation exposure for the patient will exceed a threshold if the radiation-emitting medical procedure initiated at step 410 is performed on the patient. In either case, according to an exemplary embodiment, controller 14 is programmed to make the determination at step 420 based on a threshold established by the operator of radiation-emitting medical procedure system (REMPS) 10. Such threshold is adjustable by the operator and may be expressed, for example, in units of rems, grey or rads (see element 312 of FIG. 3). Also according to an exemplary embodiment, each radiation-emitting medical procedure system (REMPS) 10 is operative to predict (i.e., estimate) how much radiation will be output and/or absorbed by a patient before a radiation-emitting medical procedure is performed.

If the determination at step 420 is negative, process flow advances to step 425 where a radiation-emitting medical procedure is performed on the patient in question. According to an exemplary embodiment, the radiation-emitting medical procedure performed at step 425 is one of the following: an X-ray, a CAT scan, a PET scan, a fluoroscopy procedure, a nuclear medicine scan, a mammography procedure, and an oncology-related radiation therapy procedure. Other types of radiation-emitting procedures may also be performed at step 425 according to principles of the present invention.

At step 430, the radiation dose for the patient from the radiation-emitting medical procedure performed at step 425 is determined. According to an exemplary embodiment, the radiation dose for the patient may be determined at step 430 automatically by radiation-emitting medical procedure system (REMPS) 10 (e.g., via controller 14 and radiation-emitting apparatus 22). Alternatively, or in addition, the radiation dose for the patient may be determined at step 430 based on an estimation by the operator that is input to radiation-emitting medical procedure system (REMPS) 10 via user input terminal 16. The amount of radiation delivered to (and absorbed by) a patient during a given radiation-emitting medical procedure varies based on a plurality of different factors unique to the specific circumstances of the particular procedure in question.

According to an exemplary embodiment, the radiation dose determined at step 430 represents an estimation of the amount of radiation that is actually absorbed by the patient during the radiation-emitting medical procedure of step 425. According to another exemplary embodiment, the radiation dose determined at step 430 represents an estimated amount of radiation that is output from radiation-emitting apparatus 22 during the radiation-emitting medical procedure of step 425. Of course, the amount of radiation that is output from radiation-emitting apparatus 22 may be used to estimate the amount of radiation that is absorbed by the patient. Such estimation techniques are generally known in the art.

At step 435, the electronic medical record (EMR) 300 for the patient in question is updated to thereby generate an updated electronic medical record (EMR) 300. According to an exemplary embodiment, controller 14 causes the amount of the radiation dose determined at step 430 to be added to the patient's current cumulative past amount of radiation exposure in electronic medical record (EMR) 300 (see element 304 of FIG. 3), to thereby generate the updated electronic medical record (EMR) 300 at step 435. Any necessary conversion between units (e.g., rems, grey, rads, etc.) is also performed by controller 14 at step 435 to facilitate the update of electronic medical record (EMR) 300. Updated electronic medical record (EMR) 300 is stored in memory 18 under the control of controller 14.

At step 440, the updated electronic medical record (EMR) 300 for the patient in question is sent to another health care provider (HCP) and/or facility when properly requested. According to an exemplary embodiment, the updated electronic medical record (EMR) 300 may be sent at step 440 to another facility, such as to another radiation-emitting medical procedure system (REMPS) 10 and/or data storage system (DS) 30 when properly requested, such as when a proper password is provided. Other types of security features may also be employed at step 440 to ensure that the request for the updated electronic medical record (EMR) 300 is properly authorized before being sent.

Referring back to step 420, if the determination at that step is positive (i.e., cumulative past radiation exposure for the patient exceeds a threshold, or will exceed a threshold if the requested radiation-emitting medical procedure is performed), process flow advances to step 445 where one or more alert outputs are provided to notify the operator of radiation-emitting medical procedure system (REMPS) 10 of this condition. According to an exemplary embodiment, controller 14 causes one or more alert outputs to be generated at step 445 and such outputs may be aural and/or visual in nature. Also when the determination at step 420 is positive, controller 14 disables radiation-emitting apparatus 22 to thereby prevent any radiation-emitting medical procedures from being performed on the patient due to his/her cumulative past radiation exposure.

From step 445, process flow advances to step 450 where a determination is made as to whether the operator wants to perform an override function and thereby perform the radiation-emitting medical is procedure on the patient despite his/her cumulative past radiation exposure. This step is particularly important, for example, in emergency and/or trauma cases where the performance of a radiation-emitting medical procedure is critical. According to an exemplary embodiment, the operator may elect to perform the override function at step 450 by providing one or more predetermined inputs to radiation-emitting medical procedure system (REMPS) 10 via user input terminal 16.

If the determination at step 450 is positive (i.e., operator performs the override function), process flow loops back to step 425 where the radiation-emitting medical procedure is performed on the patient, as originally requested. From step 425, process flow continues as shown in FIG. 4 and previously described herein.

Alternatively, if the determination at step 450 is negative (i.e., operator does not want to perform the override function), process flow advances to step 455 where the performance of the radiation-emitting medical procedure on the patient remains disabled due to his/her cumulative past radiation exposure.

As described above, the present invention provides methods and systems capable of utilizing electronic medical records to, among other things, track and manage radiation doses provided to patients through various different types of radiation-emitting medical procedures.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method, comprising:
receiving, via a system, an electronic medical record for a patient, said electronic medical record comprising data indicating a cumulative past amount of radiation exposure for said patient, and wherein for at least one past medical procedure performed on said patient that exposed said patient to radiation, said electronic medical record further comprises data indicating at least one of an amount of radiation exposure to said patient from said past medical procedure, a date said past medical procedure was performed, a type of said past medical procedure, and a name of a facility associated with said past medical procedure;
performing, via said system, a medical procedure on said patient and thereby exposing said patient to an additional amount of radiation; and
updating, via said system, said electronic medical record after performing said medical procedure to thereby generate an updated electronic medical record for said patient that reflects said additional amount of radiation.

2. The method of claim 1, wherein said type of past medical procedure includes one of an X-ray, a CAT scan, a PET scan, a CAT/PET scan, a fluoroscopy procedure, a nuclear medicine scan, a mammography procedure, and an oncology-related radiation therapy procedure.

3. The method of claim 1, wherein said cumulative past amount of radiation exposure for said patient is displayed in a user interface for a time period adjustable by an operator of said system to thereby enable said operator to observe said cumulative past amount of radiation exposure for said patient for different time periods.

4. The method of claim 1, further comprising said system determining if said cumulative past amount of radiation exposure for said patient is above a threshold before performing said medical procedure on said patient.

5. The method of claim 4, wherein said threshold is adjustable by an operator of said system.

6. The method of claim 4, wherein said system provides a pre-defined output in response to determining that said cumulative past amount of radiation exposure for said patient is above said threshold.

7. The method of claim 4, wherein said system automatically disables said performance of said medical procedure in response to determining that said cumulative past amount of radiation exposure for said patient is above said threshold.

8. The method of claim 7, wherein said system includes an override is feature for enabling an operator to cause said system to enable said performance of said medical procedure even if said system has determined that said cumulative past amount of radiation exposure for said patient is above said threshold.

9. The method of claim 1, further comprising said system sending said updated electronic medical record to another system in response to a signal requesting said updated electronic medical record.

10. A method, comprising:
storing, in a memory of a system, an electronic medical record for a patient, said stored electronic medical record comprising data indicating a cumulative past amount of radiation exposure for said patient; and
wherein for at least one past medical procedure performed on said patient that exposed said patient to radiation, said electronic medical record for said patient further comprises data indicating at least one of:
an amount of radiation exposure to said patient from said past medical procedure;
a date said past medical procedure was performed;
a type of said past medical procedure; and
a name of a facility associated with said past medical procedure.

11. The method of claim 10, wherein said at least one past medical procedure performed on said patient that exposed said patient to radiation includes at least one of an X-ray, a CAT scan, a PET scan, a CAT/PET scan, a fluoroscopy procedure, a nuclear medicine scan, a mammography procedure, and an oncology-related radiation therapy procedure.

12. The method of claim 10, further comprising:
detecting if said cumulative past amount of radiation exposure for said patient is above a threshold; and
providing a pre-defined output message to an operator of said system in is response to detecting that said cumulative past amount of radiation exposure for said patient is above said threshold.

13. The method of claim 12, wherein said detecting is performed in response to an input to said system requesting performance of a medical procedure on said patient which, if performed, will expose said patient to an additional amount of radiation.

14. A system, comprising:
means for receiving an electronic medical record for a patient, said electronic medical record comprising data indicating a cumulative past amount of radiation exposure for said patient; and
means for detecting if said cumulative past amount of radiation exposure for said patient is above a threshold and providing a pre-defined output message to an operator of said system in response to detecting that said cumulative past amount of radiation exposure for said patient is above said threshold.

15. The system of claim 14, wherein said detection is performed in response to an operator input to said system requesting performance of a medical procedure on said patient which, if performed, will expose said patient to an additional amount of radiation.

16. The system of claim 15, further comprising:
performing, via said system, said requested medical procedure on said patient without providing said pre-defined output message in response to detecting that said cumulative past amount of radiation exposure for said patient is not above to said threshold.

17. The system of claim 16, further comprising:
detecting, via said system, said additional amount of radiation; and
updating, via said system, said electronic medical record for said patient after is performing said medical procedure to thereby generate an updated electronic medical record for said patient that reflects said additional amount of radiation.

18. The system of claim 17, further comprising said system sending said updated electronic medical record to another system in response to a signal requesting said updated electronic medical record.

19. The system of claim 14, wherein said threshold is adjustable by said operator.

20. The system of claim 14, wherein for at least one past medical procedure performed on said patient that exposed said patient to radiation, said electronic medical record further comprises data indicating at least one of:
an amount of radiation exposure to said patient from said past medical procedure;
a date said past medical procedure was performed;
a type of said past medical procedure; and
a name of a facility associated with said past medical procedure.
